(19) United States
(12) Patent Application Publication
(10) Pub. No.: US 2007/0015094 A1
(43) Pub. Date: Jan. 18, 2007

(54) ELECTROMAGNETIC WAVE SHIELDING MATERIAL, METHOD FOR MANUFACTURING THE SAME AND ELECTROMAGNETIC WAVE SHIELDING MATERIAL FOR PLASMA DISPLAY PANEL

(75) Inventor: Takeshi HABU, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/427,614

(22) Filed: Jun. 29, 2006

(30) Foreign Application Priority Data
Jul. 13, 2005 (JP) JP2005-204218

(51) Int. Cl. G03C 5/16

(52) U.S. Cl. 430/348

(57) ABSTRACT

A method of manufacturing an electromagnetic wave shielding material comprising the steps of: (a) forming an image of metallic silver grains by conducting exposure and photographic processing to a silver halide photographic material comprising a support, at least one near-infrared absorption layer thereon, and a silver halide emulsion layer containing silver halide grains; and (b) converting the image of metallic silver grains to an electrical conductive image by treatment of pressing or heating.

This application is based on Japanese Patent Application No. 2005-204218 filed on Jul. 13, 2005, in Japanese Patent Office, the entire content of which is hereby incorporated by reference.

### TECHNICAL FIELD

The present invention relates to an electromagnetic wave shielding material exhibiting near-infrared absorbability and visible ray transmission, which is employed for the front surface of a plasma display panel (PDP), and to a method for manufacturing the same.

### BACKGROUND

In recent years, the need of reducing electromagnetic wave interference (EMI) has heightened due to increasing usage of electronic devices. It has been pointed out that EMI causes malfunctions and failures of electronic and electrical devices, and is also hazardous to humans. For this reason, with respect to electronic devices, it is required that the strength of electromagnetic wave emission is controlled within the range of governmental standards or regulations.

Specifically, a plasma display panel (PDP) theoretically generates electromagnetic waves because it is based on the principle that rare gases are converted to a plasma state to emit ultraviolet rays which make phosphor emit light. Further, since near-infrared rays are also emitted at this time, resulting in malfunction of operational devices, such as a remote controls, so that near-infrared shielding capability as well as electromagnetic wave shielding capability has been desirable. Electromagnetic wave shielding capability is simply represented as a surface resistance value, and in the light-transmitting electromagnetic wave shielding material for a PDP, required is a value of less than 10 Ω/sq, and in a consumer plasma television using a PDP, the required value is less than 2 Ω/sq, and the very high conductivity of less than 0.2 Ω/sq is more desirable.

Further, the desired level of near-infrared ray shielding is 60% or more, and preferably 80% or more, and still higher shielding capability is expected.

Still further, in order to enhance the function of a PDP, addition of mechanical strength to a PDP body of a thin film of glass, antireflection of sunlight, and color tone correction are desired in addition to infrared absorbability.

For this reason, plural transparent base plates are adhered to add mechanical strength, for which employed are combinations of layers, such as a conductive layer for electromagnetic wave shielding, a near-infrared absorption layer for near-infrared shielding, an antireflection layer for antireflection of sunlight, and a layer containing a dye for absorption in a visible light region.

To solve the above problems, specifically to solve the problems of electromagnetic wave shielding and near-infrared absorbability, methods satisfying both of an electromagnetic wave shielding property, proposed have been employing a metal mesh having apertures and a near-infrared shielding property employing a near-infrared absorption dye. For example, one method is to adhere a near-infrared absorption film onto a glass plate into the surface of which a metal mesh having a high aperture ratio has been burned. However, in this method, the manufacturing process of burning a metallic mesh is complicated and complex, resulting in problems of a high level of skill in manufacturing and a long processing time.

On the other hand, since the developed silver obtained from silver halide grains is metallic silver, it is possible to produce a mesh of gold or silver depending on the manufacturing method. For example, if a photographic material containing silver halide grains is exposed via a mesh and photo-processed, the conductive metallic silver portions in which silver grains gathered in the shape of the mesh can be formed. Since a binder fills the spaces among the silver grains, resulting in interference of conductivity, it is necessary to reduce the binder volume, but conductivity is not sufficiently improved only by it. Therefore, methods employing plating treatment to enhance conductivity are proposed, (please refer to, for example, Patent Documents 1 and 2). However, the manufacturing process of a plating treatment needs to employ a plating solution with the inherent problem of generating harmful effluent containing heavy metals.

In addition, in these Patent Documents, there is no description about near-infrared ray shielding, while the near-infrared rays generated from PDP cause malfunction of wireless electronic devices.

Thus, as measures to simultaneously shield both electromagnetic waves and near-infrared rays generated from electronic display devices, a method for manufacturing the shielding material from a photographic material containing silver halide grains is not at all known.

Patent Document 1: Unexamined Japanese Patent Application Publication No. (hereinafter, referred to as JP-A) 2004-221564

Patent Document 2: JP-A 2004-221565

### SUMMARY

As mentioned above, the method utilizing silver halide is complicated due to the need of conducting additional manufacturing processing such as a plating treatment, because the function as a conductive line is not sufficient, even if the particle configuration is made to smaller or the binder volume is reduced, whereas silver halide is in a form of grain.

The present invention was effected in view of the above situation. An object of the present invention is to provide an electromagnetic wave shielding material which simultaneously exhibits a high electromagnetic wave shielding property and a high near-infrared shielding property, and to provide a method for manufacturing the same with quick and simple processing, in which formation of a thin-line-state picture image is easy.

The following composition can attain the above object of the present invention.

Item 1. A method of manufacturing an electromagnetic wave shielding material comprising the steps of:

(a) forming an image of metallic silver grains by conducting exposure and photographic processing to a silver halide photographic material comprising a support, at least one near-infrared absorption layer thereon, and a silver halide emulsion layer containing silver halide grains; and

(b) converting the image of metallic silver grains to an electrical conductive image by treatment of pressing or heating.

Item 2. The method of manufacturing the electromagnetic wave shielding material of Item 1, wherein the silver halide grains are sensitized to near-infrared rays, and the silver halide photographic material is subjected to near-infrared exposure.

Item 3. The method of manufacturing the electromagnetic wave shielding material of Item 1 or 2 above, wherein the near-infrared absorption layer of the silver halide photographic material is provided between the silver halide emulsion layer and the support, or on a surface of the support opposite to the silver halide emulsion layer.

Item 4. The method of manufacturing the electromagnetic wave shielding material of any one of Items 1-3, wherein a near-infrared absorption intensity of the near-infrared absorption layer does not change by photographic processing.

Item 5. The method of manufacturing the electromagnetic wave shielding material of any one of Items 1-4, wherein an unexposed portion which is not exposed by the near-infrared exposure contains substantially no silver nor silver halide after photographic processing.

Item 6. The method of manufacturing the electromagnetic wave shielding material of any one of Items 1-5, wherein the pressing is conducted at a pressure of 1 kPa-100 MPa.

Item 7. The method of manufacturing the electromagnetic wave shielding material of any one of Items 1-6, wherein heating is conducted at a temperature of 40-300° C.

Item 8. The method of manufacturing the electromagnetic wave shielding material of Item 7, wherein heating is via laser heating.

Item 9. An electromagnetic wave shielding material, manufactured by the method of manufacturing the electromagnetic wave shielding material described in any one of Items 1-8, exhibiting:

(i) at least one characteristic of surface resistance of not more than 10 Ω/sq. or an average visible light transmission of not less than 90%;

(ii) electrical conductive portions; and

(iii) a near-infrared absorption layer.

Item 10. An electromagnetic wave shielding material for a plasma display panel comprising an electromagnetic wave shielding material of Item 9.

According to this invention, it is possible to prepare a light-transmitting electromagnetic wave shielding material which simultaneously achieves high light transmission and high conductivity (being electromagnetic wave shielding capability), and also shields from near-infrared rays to avoid malfunctions of near-infrared wireless electronic devices. Further, with this manufacturing method, the shielding material can be manufactured without discharge of hazardous effluent of plating treatment solution.

### DESCRIPTION OF THE PREFERRED EMBODIMENT

The present invention will now be described in more detail. First, the silver halide photosensitive material (it is also called a photographic material) of the present invention will be described.

In the present invention, the silver halide emulsion layer may contain a binder and a surface active agent, as well as silver halide grains.

As silver halide grains employed in this invention, listed are inorganic silver halide grains, such as silver bromide grains and organic silver halide grains, such as silver behenate grains, but it is preferable to employ inorganic silver halide grains, from which it is easy to obtain conductive metallic silver.

Silver halides preferably employed in this invention include ones which mainly contain AgCl, AgEr or AgI. To obtain a highly conductive metallic silver, it is preferable to employ microscopic silver halide grains exhibiting high sensitivity, after which preferably employed is AgBr-based silver halide containing iodine. When the iodine content is raised, it is possible to obtain microscopic silver halide grains exhibiting high sensitivity.

Silver halide grains are converted to metallic silver grains after development. Then, for electricity to flow from grain to grain, contact areas of the grains need to become as large as possible. For that purpose, it is best that grain size is reduced, but small grains easily aggregate into a large mass, and since contact areas decrease conversely, the optimal grain diameter results. As for an average grain size of a silver halide, it is preferably 1-1,000 nm (being 1 μm) in a spherical equivalent diameter, more preferably 1-100 nm, but still more preferably 1-50 nm. The spherical equivalent diameter of a silver halide grain means diameter of the sphere having an equivalent volume as the silver halide grain.

The shapes of silver halide grains are not specifically limited, and may be various shapes, such as spherical, cubic, tabular (hexagonal tabular, triangular tabular, square tabular), octahedral, or tetradecahedral shapes. In order to dramatically raise sensitivity, tabular grains exhibiting an aspect ratio of 2 or more, 4 or more, and further 8 or more and 16 or less, are preferably employed. The grain size distribution may be broad or narrow, but a narrower distribution is preferable to obtain high conductivity and a large aperture ratio. The degree of monodispersion as known in the photographic industry is preferably 100 or less, but more preferably 30 or less. From the viewpoint of enabling high electrical flow, the contact area among the formed grains is preferable as large as possible. Therefore, the shape of the grains is preferably tabular and exhibiting a large aspect ratio. However, since it is difficult to obtain high image density employing grains of a high aspect ratio, an optimum aspect ratio exists.

Silver halide employed in this invention may further contain other elements. For example, in a photographic emulsion, it is also useful to dope the metal ion to obtain a higher contrast emulsion. Specifically, transition metal ions, such as a rhodium ion, a ruthenium ion, and an iridium ion, are preferably employed, since it becomes easier to effect a difference of the exposed portions and the unexposed portions during formation of the metallic silver images. The transition metal ion represented by a rhodium ion and the iridium ion may also be a compound which has various ligands. As such a ligand, listed are a cyanide ion, a halogen ion, a thiocyanate ion, a nitrosyl ion, water, or a hydroxide ion. As an example of specific compounds, listed are potassium bromorhodiate, and potassium iridate.

In this invention, the content of the rhodium compound and/or iridium compound contained in a silver halide is preferably 10⁻¹⁰-10⁻² mol/molAg, but more preferably 10⁻⁹-10⁻³ mol/molAg, based on the molar number of silver in the silver halide.

In addition, in this invention, preferably employed may be a silver halide containing Pd ions, Pt ions, Pd metal, and/or Pt metal may also be employed. Pd or Pt may be uniformly distributed in silver halide grains, but it is preferable that Pd or Pt is contained near the surface layer of the grains.

In this invention, the content of Pd ion and/or Pd metal contained in the silver halide is preferably 10⁻⁶-0.1 mol/molAg based on the molar number of silver in the silver halide, and more preferably 0.01-0.3 mol/molAg.

Further, in this invention, the silver halide may be subjected to chemical sensitization to increase sensitivity as being conducted for a photographic emulsion. As chemical sensitization, for example, employed is noble metal sensitization, such as gold, palladium, and platinum sensitization; chalcogen sensitization, such as sulfur sensitization using inorganic sulfur or an organic sulfur compound; or reduction sensitization using tin chloride or hydrazine.

It is preferable that the chemically sensitized silver halide grains are further subjected to spectral sensitization. It was found that characteristics of the developed silver formed after photographic processing are suitable for the electromagnetic wave shielding material after a sensitizing dye is adsorbed onto the surfaces of the silver halide grains. The wavelength region of spectral sensitization may be determined to be compatible with the exposure method of the silver halide grains, but in this invention, it is specifically preferable to sensitize the material to the near-infrared region. As preferable spectral sensitizing dyes, listed are cyanine, carbocyanine, dicarbocyanine, complex cyanine, hemicyanine, a styril dye, merocyanine, complex merocyanine, and a holopolar dye. These spectral sensitizing dyes, usually employed in the photographic industry, may be utilized alone or in combinations.

Specifically useful dyes are a cyanine dye, a merocyanine dye, and a complex merocyanine dye. In these dyes, any nucleus usually contained in a cyanine dye may surve to form a basic heterocyclic ring nucleus. Namely, those are a pyrroline nucleus, an oxazoline nucleus, a thiazoline nucleus, a pyrrole nucleus, an oxazole nucleus, a thiazole nucleus, a selenazole nucleus, an imidazole nucleus, a tetrazole nucleus, a pyridine nucleus, and nuclei which are formed by coalescence of these nuclei with alicyclic hydrocarbon rings; as well as nuclei which are formed by coalescence of those nuclei with aromatic hydrocarbon rings, that is, an indolenine nucleus, a benzindolenine nucleus, an indole nucleus, a benzoxazole nucleus, a naphthoxazole nucleus, a benzothiazole nucleus, a naphth thiazole nucleus, a benzselenazole nucleus, a benzimidazole nucleus, and a quinoline nucleus. These nuclei may be substituted on a carbon atom.

In a merocyanine dye or complex merocyanine dye, as a nucleus which features a ketomethylene structure, applicable are 5-6 membered heterocyclic ring nuclei, such as a pyrazoline-5-one nucleus, a thiohydantoin nucleus, a 2-thiooxazolidine-2, a 4-dion nucleus, a thiazolidine-2, a 4-dione nucleus, a rhodanine nucleus, and a thiobarbituric acid nucleus. Specifically preferable sensitizing dye is a near-infrared sensitizing dye. These dyes are based on JP-A Nos. 2000-347343, 2004-037711, and 2005-134710, preferable examples of which are shown below.

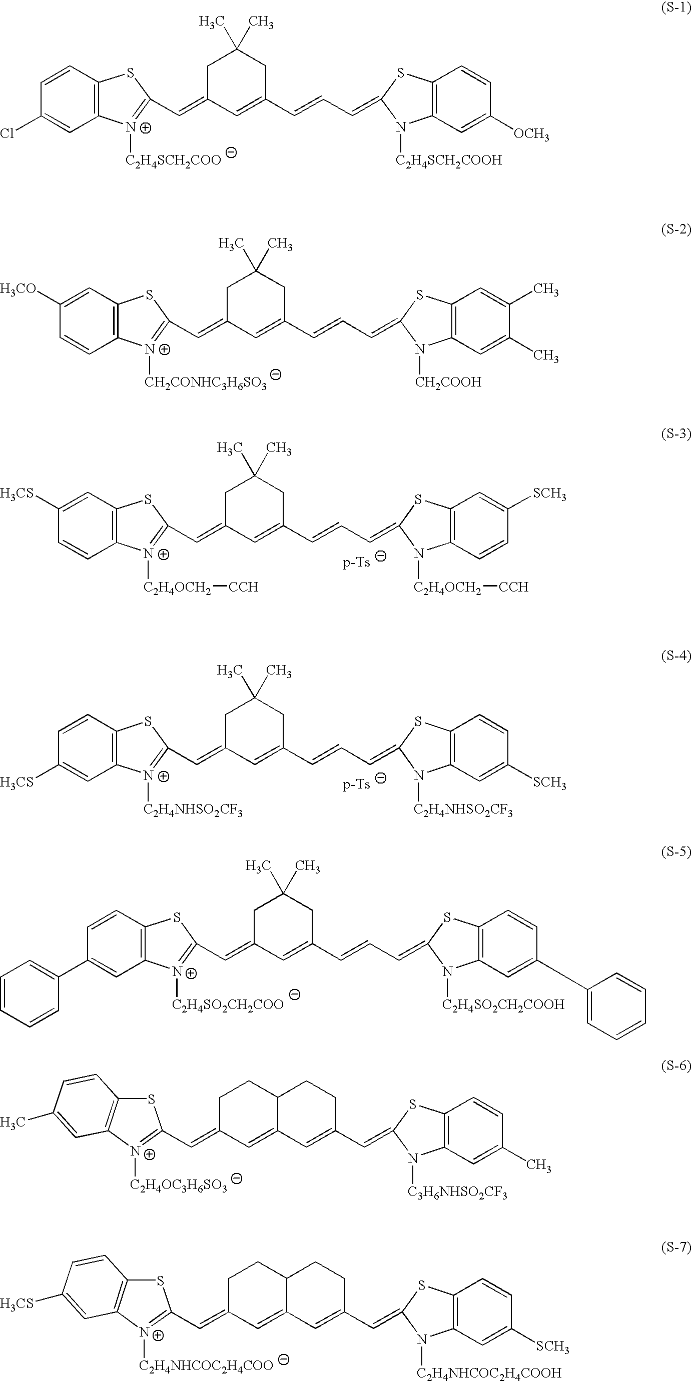

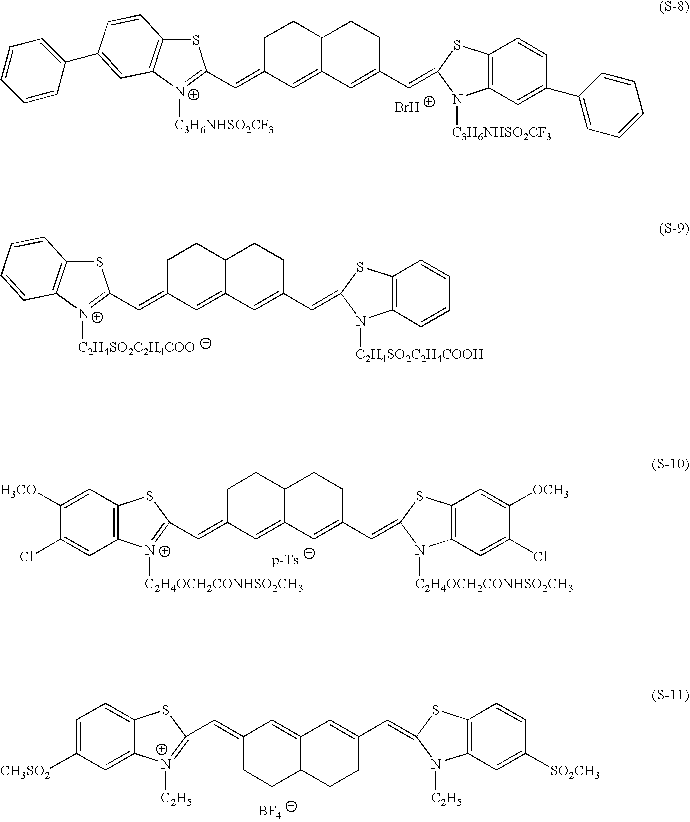

These sensitizing dyes may be employed alone or in combinations. Specifically, combinations of sensitizing dyes are often employed to achieve supersensitization.

To incorporate these sensitizing dyes in a silver halide emulsion, they may be directly dispersed in the emulsion, or may be added after being dissolved in a single or mixed solvent, such as water, methanol, propanol, methyl cellosolve, or 2,2,3,3-tetra-fluoro propanol. Further, the dyes may be added as an aqueous solution under coexistence of an acid or a base, as described in Examined Japanese Patent Publication Nos. (hereinafter, referred to as JP-B) 44-23389, 44-27555, and 57-22089, or they may be added to the emulsion after having been dissolved as an aqueous solution or colloidal dispersion employing a surface active agent, such as sodium dodecylbenzenesulfonate, as described in U.S. Pat. Nos. 3,822,135, and 4,006,025. Further, the dyes may be added to the emulsion, after having been dissolved in a basically water immiscible solvent, such as phenoxyethanol as well as being dispersed in water or a hydrophilic colloidal. Also, the dyes may be added to the emulsion as a dispersion in which the dyes are directly dispersed into a hydrophilic colloid, as described in JP-A Nos. 53-102733 and 58-105141.

As a contrast increasing method of the silver halide grains, may be a method to raise the silver chloride content and to decrease the distribution range of grain diameter. In the printing plate field, to drastically raise the contrast, known is employment of a hydrazine compound and a tetrazolium compound as a contrast-increasing agent. A hydrazine compound is a compound which has an —NHNH— group, typical examples of which will be shown in the following formulas.
T-NHNHCO—V, T-NHNHCOCO—V

In the above formulas, T is an aryl group or a hetero ring group, each of which may be substituted. The aryl group represented by T contains a benzene or naphthalene ring, which rings may have a substituent, and preferable examples of the substituents include a straight or blanched alkyl group (being preferably a methyl group, an ethyl group, an isopropyl group, or an N-dodecyl group, having 2-20 carbon atoms); an alkoxy group (being preferably a methoxy group, or an ethoxy group, having 2-21 carbon atoms); an aliphatic acylamino group (being preferably an acetylamino group, or a heptylamino group, having an alkyl group of 2-21 carbon atoms); and an aromatic acylamino group. In addition to these groups, are for example, groups in which the above substituted or unsubstituted aromatic rings are linked with a linkage group, such as —CONH—, —O—, —SO₂NH—, —NHCONH—, or —CH₂CHN—. V is a hydrogen atom, an alkyl group (e.g., a methyl group, an ethyl group, a butyl group, or a trifluoro methyl group); an aryl group (e.g., a phenyl group, or a naphthyl group); or a heterocyclic group (e.g., a pyridyl group, the piperidyl group, a pyrrolidyl group, a furanyl group, a thiophene group, and a pyrrole group); all of which groups may be substituted.

Hydrazine compounds may be synthesized based on methods described in U.S. Pat. No. 4,269,929, and may be incorporated in the emulsion layer, an hydrophilic colloid layer adjacent to the emulsion layer, or other hydrophilic colloid layers.

Specifically preferable hydrazine compounds are listed below.

(H-1): 1-trifluoromethylcarbonyl-2-{[4-(3-n-butylureido) phenyl]}hydrazine

(H-2): 1-trifluoromethylcarbonyl-2-{4-[2-(2,4-di-tert-pentylpPhenoxy) butylamide]phenyl}hydrazine

(H-3): 1-(2,2,6,6-tetramethylpiperidyl-4-amino-oxazaryl)-2-{4-[2-(2,4-di-tert-pentylphenoxy)butylamide] phenylsulphoneamidephenyl}hydrazine

(H-4): 1-(2,2,6,6-tetramethylpiperidyl-4-amino-oxalyl)-2-{4-[2-(2,4-di-tert-pentylphenoxy)butylamide] phenylsulfonamidephenyl} hydrazine

(H-5): 1-(2,2,6,-tetramethylpiperidyl-4-amino-oxalyl)-2-{4-[3-(4-chlorophenyl-4-phenyl-3-thia-butaneamide) benzenesulfonamide] phenyl} hydrazine

(H-6): 1-(2,2,6,6-tetramethylpiperidyl-4-amino-oxalyl)-2-[4-(3-thia-6,9,12,15-tetraoxatricosaneamide) benzenesulphoneamide] phenylhydrazine

(H-7): 1-(1-methylenecarbonylpyridinium)-2-[4-(3-thia-6,9,12,15-tetra-oxatricosaneamide) benzenesulfonamide] phenylhydrazine chloride

Specifically preferable hydrazine compounds are ones in which the T group is substituted with a sulphoneamidephenyl group and which V group is substituted with a trifluoromethyl group. Further, the oxalyl group linked to the hydrazine is specifically preferably a pypelydylamino group which may be substituted. Examples of a tetrazolium compounds are shown below.

(T-1): 2,3-di (p-methylphenyl)-5-phenyltetrazolium chloride

(T-2): 2,3-di (p-ethylPhenyl)-5-phenyltetrazolium chloride

(T-3): 2,3,5-tri-p-methylphenyltetrazolium chloride

(T-4): 2,3-diphenyl-5-(P-methoxyphenyl) tetrazolium chloride

(T-5): 2,3-di (O-methylphenyl)-5-phenyltetrazolium chloride

(T-6): 2,3,5-tri-p-methoxyphenyltetrazolium chloride

(T-7): 2,3-di (o-methylphenyl)-5-phenyltetrazolium chloride

(T-8): 2,3-di (m-methylphenyl)-5-Phenyltetrazolium chloride

(T-9): 2,3,5-tri-p-ethoxymethylphenyltetrazolium chloride

These may be employed based on the description in JP-B 5-58175, and in some cases, may be employed in combinations with hydrazine compounds.

When employing a hydrazine as a contrast increasing agent, an amine compound or a pyridine compound may be employed to strengthen the reduction action of hydrazine. A typical amine compound may be represented by the following formula, which contains at least one nitrogen atom.
R—N(Z)-Q
or
R—N(Z)-L-N(W)-Q

In the above formula, R, Q, Z, and W are an alkyl group of 2-30 carbon atoms which may be substituted. Further, these alkyl group chains may be linked with a hetero atom, such as nitrogen, sulfur, and oxygen. R and Z, or Q and W, may mutually form a saturated or unsaturated ring. L is a divalent linkage group, which may contain a heteroatom, such as sulfur, oxygen, or nitrogen. Carbon atoms from 1-200 in the linkage group are possible, and sulfur atoms may be 1-30, nitrogen atoms may be 1-20, and oxygen atoms may be 1-40, but these are not meant to be limited. Specific examples of these amine compounds follow.

(A-1): diethylamino ethanol

(A-2): dimethylamino-1

(A-3): 2-propanediol

(A-4): 5-amino-1-pentanol

(A-5): diethylamine

(A-6): methylamine

(A-7): triethylamine

(A-8): dipropylamine

(A-9): 3-dimethylamino-1-propanol

(A-10): 1-dimethylamino-2-propanol

(A-11): bis (dimethylaminotetraethoxy) thioether

(A-12): bis (diethylaminopentaethoxy) thioether

(A-13): bis (piperidinotetraethoxy) thioether

(A-14): bis (piperidinoethoxyethyl) thioether

(A-15): bis (nipecotinediethoxy) thioether

(A-16): bis (dicyanoethylaminodiethoxy) ether

(A-17): bis (diethoxyethylaminotetraethoxy) ether

(A-18): 5-dibutylaminoethylcarbamoyl benzotriazole

(A-19): 5-morpholinoethylcarbamoyl benzotriazole

(A-20): 5-(2-methylimidazole-2-ethylene) carbamoyl benzotriazole

(A-21): 5-dimethylaminoethylureylene benzotriazole

(A-22): 5-diethylaminoethylureylene benzotriazole

(A-23): 1-diethylamino-2-(6-aminopurine) ethane

(A-24): 1-(dimethylaminoethyl)-5-mercaptotetrazole

(A-25): 1-piperidinoethyl-5-mercaptotetrazole

(A-26): 1-dimethylamino-5-mercaptotetrazole

(A-27): 2-mercapto-5-dimethylaminoethylthio thiadiazole

(A-28): 1-mercapto-2-morpholinoethane

As an amine compound, specifically preferred is one which contains in the molecule at least one piperidine ring or a pyrrolidine ring, at least one thioether linkage, and at least two ether linkages.

A pyridinium compound or a phosphonium compound may be employed other than an amine compound as a compound to strengthen the reduction action of hydrazine. It is assumed that since an onium compound is tinged with a positive charge, it adsorbs onto the negatively charged silver halide grain, which enhances contrast by promoting electron injection from the developing agents during development.

Preferable pyridinium compounds are listed in the bis-pyridinium compounds of JP-A Nos. 5-53231 and 6-242534. Specifically preferable pyridinium compounds are ones having a bis-pyridinium form by linkage at the 1- and 4-position of pyridinium. As a salt form, preferably listed are a halogen anion, such as a chlorine ion and a bromine ion, as well as a boron tetrafluoride ion and a perchlorate ion, of which the chlorine ion and boron tetrafluorate ion are more preferable. Examples of preferable bis-pyridinium compounds follow.

(P-1): 1,1′-dimethyl-4,4′-bipyridinium dichloride

(P-2): 1,1′-dibenzyl-4,4′-bipyridinium dichloride

(P-3): 1,1′-diheptyl-4,4′-bipyridinium dichloride

(P-4): 1,1′-di-n-octyl-4,4′-dipyridium dichloride

(P-5): 4,4′-dimethyl-1,1′-bipyridinium dichloride

(P-6): 4,4′-dibenzyl-1,1′-bipyridinium dichloride

(P-7): 4,4′-diheptyl-1,1′-bipyridinium dichloride

(P-8): 4,4′-di-n-octyl-1,1′-bipyridinium dichloride

(P-9): bis (4,4′-diacetoamide-1,1′-tetramethylene bipyridinium) dichloride

Although a hydrazine compound acts to increase contrast in high density areas, the contrast increase in the toe portion is not sufficient, so that, the technique of utilizing the developing agent oxidant generated during development is considered as a means to decrease this drawback. A redox compound which reacts with the developing agent oxidant is incorporated to release an inhibitor which works to restrain development in the toe portion of the image, resulting in enhanced sharpness of the image. Since the developing agent oxidant is generated based on the progress of development, generation of the oxidant relates to the reduction rate of grains. Since this effect can be enhanced in cases when the developing nuclei exhibiting a high speed reduction rate are formed by a chemical sensitizing agent, suitable chemical sensitizing agents are desired. If the compound of the present invention is employed, marked by high effects can be obtained when using a redox compound.

A redox compound incorporates a redox group, from such as hydroquinones, catechols, naphthohydroquinones, aminophenol, pyrazolidones, hydrazines, and reductones. Preferable redox compounds include compounds which have an —NHNH-group as a redox group, typical componds of which are represented by the following formulas.
T-NHNHCO—V-(Time)n-PUG
T-NHNHCOCO—V-(Time)n-PUG

In the above formulas, T and V are such groups identical to the above hydrazine compound. PUG is a photographically beneficial group, listed examples of which are 5-nitroindazole, 4-nitroindazole, 1-phenyltetrazole, 1-(3-sulfophenyl) tetrazole, 5-nitrobenztriazole, 4-nitrobenztriazole, 5-nitroimidazole, and 4-nitroimidazole. These development restraining groups may be directly linked to a CO site of T-NHNH—CO— via a hetero atom, such as N and S, or linked to the CO site via an alkylene, a phenylene, an alalkylene, an aralkylene, or an aryl group which are represented by (Time), further via hetero atoms, such as N and S. In addition, employed may be the compounds incorporating a development restraining group, such as triazole, indazole, imidazole, thiazole, and thiadiazole, into the hydroquinone compound having a ballast group. Listed are, for example, 2-(dodecylethyleneoxide) thiopropionic acid amide-5-(5-nitroindazole-2-yl) hydroquinone, 2-(stearylamide)-5-(1-phenyltetrazole-5-thio) hydroquinone, 2-(2,4-di-t-amylphenylpropionic acid amide)-5-(5-nitrotriazole-2-yl) hydroquinone, and 2-dodecylthio-5-(2-mercaptothiothiadiazole-5-thio) hydroquinone, in which n is 1 or 0. The redox compounds may be synthesized based on the descriptions in U.S. Pat. No. 4,269,929. Specifically preferable redox compounds are listed below.

(R-1): 1-(4-nitroindazole-2-yl-carbonyl)-2-{[4-(3-n-butylureido) phenyl]} hydrazine

(R-2): 1-(5-nitroindazole-2-yl-carbonyl)-2-{4-[2-(2,4-di-tertpentylphenoxy) butylamide] phenyl} hydrazine

(R-3): 1-(4-nitrotriazole-2-yl-carbonyl)-2-{4-[2-(2, 4-di-tert-pentylphenoxy) butylamide] phenyl} hydrazine

(R-4): 1-(4-nitroimidazole-2-yl-carbonyl)-2-{4-[2-(2,4-di-tert-pentylphenoxy) butylamide] phenyl sulfonamidephenyl} hydrazine

(R-5): 1-(1-sulfophenyltetrazole-4-methyloxazole)-2-[3-(1-phenyl-1′-p-clorophenylmethane thioglycineamidephenyl) sulfonamidephenyl] hydrazine

(R-6): 1-(4-nitroindazole-2-yl-carbonyl)-2-{[4-(octyl-tetra-ethyleneoxide)-thio-glycineamidephenyl-sulfonamidephenyl]} hydrazine

A hydrazine compound, an amine compound, a pyridinium compound, a tetrazolium compound, and a redox compound are preferably incorporated at 1×10⁻⁶-5×10⁻² mol per mol of silver halide, and but preferably at 1×10⁻⁴-2×10⁻² mol. It is easy to adjust contrast increasing degree γ when it is more than 6 by control of the added amount of these compounds. γ may further be adjusted by control of monodispersibility of the emulsion, the added amount of rhodium, and chemical sensitization. Herein, γ is the density difference over the difference of each exposure amount at densities of 0.1 and 3.0.

These compounds are employed by addition to the silver halide emulsion layers or other hydrophilic colloid layers of a photographic material. They may be added to the silver halide emulsion or a hydrophilic colloid solution, in the form of an aqueous solution when they are water soluble, or in the form of a solution of a water-miscible organic solvent, such as alcohols, esters, and ketones when they are water insoluble. Further, in cases when they are not soluble in these organic solvents, it is possible to add these compounds into the emulsion by changing them into micro-particles of 0.01-10.0 μm employing a ball mill, a sand mill, or a jet mill. Micro-particle dispersion is preferably applied with the method of solid dispersion of the dye, which serves as a photographic emulsion additive.

A near-infrared absorption layer can be applied onto the photographic material. It is common to apply layers such as an adhesive layer/an antistatic layer/a near-infrared dye containing layer/and a protective layer onto the support. After applying a vinylidene chloride copolymer or a styrene-glycidyl acrylate copolymer of 0.1-1.0 μm as an adhesive layer on the support which is subjected to corona discharge, to serve as an antistatic layer may be a gelatin layer, an acrylic or a methacrylic polymer layer, or a non-acrylic polymer layer, which contains micro-particles of tin oxide or vanadium pentoxide exhibiting an average grain diameter of 0.01-1.0 μm into which indium and/or phosphorus are doped. Further, applied may be a layer formed of a copolymer of styrenesulfonic acid and maleic acid with the above-mentioned aziridine or a carbonyl activated cross-linking agent. A dye layer is applied onto these antistatic layers to serve as a near-infrared absorption layer. In that near-infrared absorption layer, incorporated may be colloidal silica; complex colloidal silica which is produced by coating onto a colloidal silica surface, with a methacrylate or acrylate polymer, or a non-acrylate polymer, such as styrene polymer and acrylamide; an inorganic or complex filler for dimensional stability; a matting agent, such as silica or methyl methacrylate to prevent adhesion; a silicone slipping agent for conveyance control; and a releasing agent. As a dye for a backing layer, employed may be a benzylidene dye or an oxonol dye. These alkali soluble or alkali degradable dyes may be fixed by forming them as micro-particles. Density for antihalation is preferably 0.1-2.0 at each photosensitive wavelength.

The antistatic agent employed in the near-infrared absorption layer may also be employed on the emulsion layer side, and it may be incorporated in a protective layer of the upper layer of the emulsion layer; or either layer or both layers of the protective layer, when the protective layer features two layers; an antihalation layer as a lower layer of the emulsion layer; an inhibiter releasing layer; or a timing layer.

A photographic material can be dried by applying the drying theories in chemical engineering. A humidity providing method during drying is appropriately chosen, since it changes based on characteristics of the photographic material. Quick drying often deteriorates the desired characteristics of the photographic material, resulting in such as high fogging or poor storage stability. The silver halide photographic material of this invention is preferably dried between 30-90° C., and at a relative humidity of of less than 20% for 10-120 seconds, but more preferably between 35-50° C. for 30-50 seconds. Specifically, regarding set up of temperature and humidity, it is desirable to control constant rate drying and falling rate drying. Constant rate drying is a process in which drying is performed as water vaporizes from the film surface, and in this process, the surface temperature is kept constant, and is thus called constant rate drying. In the next process, drying is performed as water vaporizes from the interior of the film, and the wet-bulb temperature approaches that of the film surface temperature, that is, the dry-bulb temperature, both of which finally become the same temperature. This process is thus known as falling rate drying. In drying of the gelatin film, the boundary of constant rate drying and falling rate drying is a point where the contained water is at a factor of 300-400 times the gelatin weight. A drying condition of the water content being a factor of less than 300 times has important significance in the drying condition of the falling rate drying duration. Since productivity increases due to drying at a high temperature as well as a low humidity in the falling rate drying duration, desired is a photographic material exhibiting minimal fluctuation of the desired photographic characteristics, or no deterioration of the desired characteristics under these conditions.

Core-set curl of the support is decreased by application of a heat treatment after coating, and resulting in drying of the photographic material. To decrease the core-set curl, the heat treatment is conducted between 30-90° C. for one-240 hours. Specifically preferred however is 35-50° C. for 60-120 hours.

Malfunction of electronic devices by near-infrared rays can be prevented by preparation of a near-infrared ray absorption dye layer between the emulsion layer and the support, or by preparation of a near-infrared ray absorption dye layer on the side of the support opposite the emulsion layer.

As specific examples of near-infrared absorption agents, listed are compounds of a polymethine system, a phthalocyanine system, a naphthalocyanine system, a metal complex system, an aminium system, an imonium system, a diimonium system, an anthraquinone system, a dithiol metal complex system, a naphthoquinone system, an indophenol system, an azo system, and a triarylmethane system. In an optical filter for PDP, requirement of capability of near-infrared absorption is mainly due to heat ray absorption and noise prevention of electronic devices. Therefore, preferred are dyes which exhibit near-infrared absorption capability and a maximum absorption wavelength of 750-1100 nm, and specifically preferable are compounds of a metal complex system, an aminium system, a phthalocyanine system, a naphthalocyanine system, and a diimonium system.

The absorption maximum of the conventionally known nickel dithiol complex system compound or a fluorinated phthalocyanine system compound is 700-900 nm, and put into practical use, usually, an effective near-infrared absorption effect can be obtained by employing them in combination with the aminium system compound, especially a diimonium system compound exhibiting the absorption maximum in a longer wavelength region than the above compound. (Please also refer to JP-A Nos. 10-283939, 11-73115, and 11-231106.) In addition, bis(l-thio-2-phenolate) nickel-tetrabutyl onium salt complex of JP-A 9-230931, bis(1-thio-2-naphthlate) nickel-tetrabutyl ammonium salt complex of JP-A 10-307540 may be cited.

Examples of specific compounds of diimonium system compounds are shown below.

(IR-1): N,N,N′,N′-tetrakis(4-di-n-butylaminophenyl)-1,4-benzoquinone-bis(imonium.hexafluoroantimonic acid),

(IR-2): N,N,N′,N′-tetrakis(4-di-n-butylaminophenyl)-1,4-benzoquinone-bis(imonium.perchloric acid),

(IR-3): N,N,N′,N′-tetrakis(4-di-amylaminophenyl)-1,4-benzoquinone-bis(imonium.hexafluoroantimonic acid),

(IR-4): N,N,N′,N′-tetrakis(4-di-n-propylaminophenyl)-1,4-benzoquinone-bis(imonium.hexafluoroantimonic acid),

(IR-5): N,N,N′,N′-tetrakis(4-di-n-hexylaminophenyl)-1,4-benzoquinone-bis(imonium.hexafluoroantimonic acid),

(IR-6): N,N,N′,N′-tetrakis(4-di-iso-propylaminophenyl)-1,4-benzoquinone-bis(imonium.hexafluoroantimonic acid),

(IR-7): N,N,N′,N′-tetrakis(4-di-n-pentylaminophenyl)-1,4-benzoquinone-bis(imonium.hexafluoroantimonic acid),

(IR-8): N,N,N′,N′-tetrakis(4-di-methylaminophenyl)-1,4-benzoquinone-bis(imonium.hexafluoroantimonic acid),

In addition, when a dye exhibiting near-infrared absorption capability is incorporated in an image tone correction layer, any one of the above dyes may be incorporated alone, but two or more kinds may also be incorporated. To avoid aging deterioration of the near-infrared absorption dye, it is preferable to employ an ultraviolet absorption dye.

As a UV absorbing agent, a well-known UV absorbing agent, for example, a salicylic acid system compound, a benzophenone system compound, a benzotriazole system compound, an S-triazine system compound, or a cyclic imino ester system compound may be employed preferably. Of these, preferable are a benzophenone system compound, a benzotriazole system compound, and a cyclic imino ester system compound. As to what is blended into the polyester, specifically preferable is a cyclic imino ester system compound. Preferably specific examples of which are:

(UV-1): 2-(2-hydroxy-3,5-di-α-cumyl)-2H-benzotriazole

(UV-2): 5-chloro-2-(2-hydroxy-3-tert-butyl-5-methylphenyl)-2H-benzotriazole

(UV-3): 5-chloro-2-(2-hydroxy-3,5-di-tert-butylphenyl)-2H-benzotriazole

(UV-4): 5-chloro-2-(2-hydroxy-3,5-di-α-cumylphenyl)-2H-benzotriazole

(UV-5): 5-chloro-2-(2-hydroxy-3-α-cumyl-5-tert-octylphenyl)-2H-benzotriazole

(UV-6): 2-[3-tert-butyl-2-hydroxy-5-(2-isooctyloxycarbonylethyl)phenyl]-5-chloro-2H-benzotriazole

(UV-7): 5-trifluoromethyl-2-(2-hydroxy-3-α-cumyl-5-tert-octylphenyl)-2H-benzotriazole

(UV-8): 5-trifluoromethyl-2-(2-hydroxy-5-tert-octylphenyl)-2H-benzotriazole

(UV-9): 5-trifluoromethyl-2-(2-hydroxy-3,5-di-tert-octylphenyl)-2H-benzotriazole

(UV-10): 3-methyl(5-trifluoromethyl-2H-benzotriazole-2-yl)-5-tert-butyl-4-hydroxyhydrocinnamate

(UV-11): 5-butylsulfonyl-2-(2-hydroxy-3-α-cumyl-5-tert-octylphenyl)-2H-benzotriazole

(UV-12): 5-trifluoromethyl-2-(2-hydroxy-3-α-cumyl-5-tert-butylphenyl)-2H-benzotriazole

(UV-13): 2,4-bis(4-biphenylyl)-6-(2-hydroxy-4-octyloxycarbonylethylideneoxyphenyl)-s-triazine

(UV-14): 2,4-bis(2,4-dimethylphenyl)-6-[2-hydroxy-4-(3-nonyloxy*-2-hydroxypropyloxy)-5-α-cumylphenyl]-s-triazine (*: mixture of an octyloxy group, a nonyloxy group and a decyloxy group)

(UV-15): 2,4,6-tris(2-hydroxy-4-isooctyloxycarbonylisopropylideneoxypnenyl)-s-triazine

(UV-16): hydroxyphenyl-2H-benzotriazole

(UV-17): 2-(2-hydroxy-5-methylphenyl)-2H-benzotriazole

(UV-18): 2-(3,5-di-tert-butyl-2-hydroxyphenyl)-2H-benzotriazole

The above dyes are preferably fixed in the dye layer as 0.01-10.0 μm micro-particles employing an atomizing machine, to be mentioned later, and the added amount is one which preferably attain an optical density in the range of 0.05-3.0 at the maximum wavelength.

In the silver halide grain containing layer of the present invention, a binder may be employed to uniformly disperse the silver halide grains and also to enhance adhesion between the silver halide grain containing layer and the support. In the present invention, either a non-water soluble polymer or a water soluble polymer may be employed as a binder, but preferable is a water-soluble polymer.

Listed as a binder, for example, may be gelatin, polyvinyl alcohol (PVA) and its derivatives; polyvinyl pyrrolidone (PVP); polysaccharides, such as starch, cellulose and its derivatives; polyethylene oxide; polyvinyl amine; and polyacrylic acid. These compounds exhibit a neutral, anionic or cationic nature, by ionicity of the functional group.

The content of the binder contained in the silver halide grain containing layer of the present invention is not specifically limited, but may be determined in the range of exhibiting dispersibility and adhesion property, as suitable. The content of the binder in the silver halide grain containing layer is preferably 0.2-100.0 in the weight ratio of Ag/binder, is more preferably 0.3-30.0, and is still more preferably 0.5-15.0. In cases when Ag is incorporated at 0.5 or more compared to the binder of the weight ratio in the silver halide grain containing layer, it is possible to attain higher electrical conductivity since metallic particles tend to contact each other more readily following heat-pressing treatment, which is preferable.

In the present invention, a plastic film, a plastic plate, or a glass plate may be employed as a support. Examples of raw materials of a plastic film and a plastic plate include, for example, polyesters, such as a polyethylene terephthalate (PET) and polyethylenenaphthalate (PEN); vinyl resin, such as polyethylene (PE), polypropylen (PP), and polystyrene; polycarbonate (PC); and triacetyl cellulose (TAC).

From the viewpoint of transparency, heat resistance, ease of handling, and cost, the above plastic film is preferably PET, PEN, or TAC.

In the electromagnetic wave shielding material for a display, high transparency is essential, so high transparency of the support is preferable. In this case, the total visible light transmittance of the plastic film or plastic plate is preferably 70-100%, more preferably 80-100%, and still more preferably 90-100%. Further, in the present invention, employed may be the above plastic film or the plastic plate colored with a tint adjusting agent, but must not impede the targeted objects of this invention.

Solvents employed for preparation of the coating solutions for the silver halide emulsion layer of this invention are not specifically limited, but cited may be water, organic solvents (for example, alcohols such as methanol and ethanol; ketones, such as acetone, methyl ethyl ketone, and methyl isobutyl ketone; amides, such as formamide; sulfoxide, such as dimethyl sulfoxide; esters, such as ethyl acetate; and ethers), ionic liquids, and mixed solvents of these.

The content of the solvent employed in the silver halide emulsion layer of this invention is preferably in the range of 30-90 wt % compared to the total weight of the silver halide grains along with the binder contained in the above silver containing layer, and is more preferably in the range of 40-80 wt %.

In this invention, exposure is conducted on the silver halide emulsion layer applied on the support. Exposure may be performed employing electromagnetic waves. Listed as electromagnetic waves are, for example, light, such as visible light and UV light; and radioactive rays, such as electronic beams, and X-rays, but UV light or near-infrared rays are preferable. Further, a light source which has an appropriate wavelength distribution may be employed for light exposure, however a light source of a narrow wavelength distribution may also be employed for light exposure.

To obtain visible light, employed may be various luminous bodies exhibiting photogenesis in the appropriate spectral regions. For example, employed may be any one of a red luminous body, a green luminous body, or a blue luminous body, or a mixture of at least two of them. The spectral regions are not limited to the above red, green and blue, and also employed may be luminous bodies of yellow, orange or violet, or a fluorescent material producing luminescence in the infrared region. Further, an ultraviolet lamp is also preferable, and g-beams or I-beams of a mercury lamp may also be employed.

Further, in this invention, exposure may be conducted with employment of various laser beams. For example, exposure of this invention is preferably conducted employing a scanning exposure method with a monochromatic high-density beam using a gas laser, a light-emitting diode, a semiconductor laser, a second harmonic generation (SHG) light source combined a nonlinear optical crystal and a semiconductor laser, or a solid-state laser which employs a semiconductor laser as an excitation light source. Further, a KrF excimer laser, an ArF excimer laser, and an F2 laser may also be employed. To keep the system compact and high efficiency, exposure is preferably conducted employing a semiconductor laser, or a second harmonic generation light source (SHG) combined a semiconductor laser or a solid-state laser, and a nonlinear optical crystal. Specifically, to design a compact device featuring high efficiency, longer-life and being highly stable, exposure is preferably conducted employing a semiconductor laser.

Specifically, as a laser light source, preferably cited are an ultraviolet semiconductor laser, a blue semiconductor laser, a green semiconductor laser, a red semiconductor laser, and a near-infrared laser.

An image exposure method on a silver halide grain containing layer may be employed with plane exposure using a photomask, or scanning exposure using laser beams. In this case, exposure may be via a condenser type exposure employing a lens or a reflector type exposure employing a reflecting mirror, and employed may be an exposure method of face-to-face contacting exposure, near-field exposure, reduction-projection exposure, or reflective projection exposure. Since output power from a laser is required to be of a suitable quantity to expose the silver halide, it is acceptable at a level of several μW-5 W.

In the present invention, after exposure on a silver halide emulsion layer, photographic processing is further conducted. The usual photographic processing technique employed for silver halide grain photographic film, printing paper and graphic arts printing film, as well as an emulsion mask for photomasking, may be employed. The developing solution is not specifically limited, but it is preferable to employ a PQ developing solution, an MQ developing solution, or an MAA developing solution. In this invention, metallic silver portions, preferably being image producing metallic silver portions, are formed together with light transparent portions, described later, by conducting the above exposure and photographic processing.

The photographic processing in this invention may include fixing process performed in order to remove the silver halide grains in the unexposed portions and stabilize those kinds of grains in the exposed areas. In the fixing process of this invention, the fixing process technique employed for silver halide grain photographic film, printing paper and graphic arts printing film, as well as an emulsion mask for photomasking, are preferred.

[Addition]

In the present invention, the expression of “an unexposed portion contains substantially no silver nor silver halide” means that in the unexposed portion, “density” is not more than 0.3 after photographic processing.

The developing solution composition employed for this invention may include hydroquinones as a developing agent, such as hydroquinone, sodium hydroquinone sulfonate, and chlorohydroquinone, and together in combination with these, employed may be a superadditive developing agent, such as pyrazolidones, e.g., 1-phenyl-3-pyrazolidone, 1-phenyl-4,4-dimethyl-3-pyrazolidone, 1-phenyl-4-methyl-4-hydroxymethyl-3-pyrazolidone, and 1-phenyl-4-methyl-3-pyrazolidone; and N-methyl-p-aminophenol sulfate. Further, it is preferable to employ reductone compounds, such as ascorbic acid and D-iso-ascorbic acid, without using hydroquinone.

A sodium sulfite salt or a potassium sulfite salt may be incorporated as a preserving agent, and a sodium carbonate salt or a potassium carbonate salt may be incorporated as a buffering agent, and diethanolamine, or triethanolamine, and diethylamino propanediol may be incorporated as a development accelerator.

The developing solution pH may be adjusted to the range of 9-12 with an alkaline chemical, such as sodium hydroxide or potassium hydroxide. The pH may generally be set in the range of 10±0.5 for storage stability, but it may also be set in the range of 11±0.5 for a rapid processing. Photographic processing may be conducted under the conditions of 20-40° C., for 1-90 seconds. Further, the replenishing rate of the developing solutions or fixing solutions may be set to the range of 5-216 ml per m², or less than this when using a development accelerator or a sensitizer. As for reduction of the replenishing rate, it is specifically effective that the amount of silver halide grains is reduced based on the sensitization technique of the emulsion, and reduction of the replenishing rate is achieved by reduction of silver halide grains together with the above developing acceleration technique.

The developing solution employed in photographic processing may incorporate a quality improving agent for the purpose to raise image quality. As such a picture quality improving agent, cited for example, is a nitrogen containing heterocyclic compound, such as 1-phenyl-5-mercaptotetrazole and 5-methylbenzotriazole.

Image contrast, after photographic processing in this invention, is not specifically limited, but it preferably exceeds 4.0. If the contrast after photographic processing exceeds 3.0, the electrical conductivity in the conductive metallic portions may be increased to maintain higher transparency in the light transparent portions. As a method to maintain a contrast of 3.0 or more, cited is, for example, doping of the foregoing rhodium or iridium ions.

A fixing solution may be incorporated in this invention such as sodium thiosulfate, potassium thiosulfate, or ammonium thiosulfate as a fixing agent. Aluminium sulfate, or chromium sulfate may be employed as a hardening agent at the time of fixing. As a preserving agent of the fixing agent, employed may be sodium sulfite, potassium sulfite, ascorbic acid, and erythorbic acid, which are described in the developing composition, while in addition, citric acid, or oxalic acid may also be employed.

Employed may be as an antifungal agent in the washing water used in the present invention, N-methyl-isothiazole-3-one, N-methyl-isothiazole-5-chloro-3-one, N-methyl-isothiazole-4,5-dichloro-3-one, 2-nitroglycerine-2-bromine-3-hydroxypropanol, 2-methyl-4-chlorophenol, or hydrogen peroxide.

Next, the conductive metallic portions of this invention will be described.

In the present invention, the conductive metallic portions are formed by dispersed conductive metal particles in the foregoing metallic silver portions under a pressing treatment. Pressing onto the electromagnetic wave shielding material of this invention is performed by face-to-face pressing in which pressure is applied onto the material laying on a plate, nip-roller pressing in which pressure is applied to the material while it passes between rollers, or a combined pressing process of these. The amount of pressure is appropriately chosen within 1 kPa-100 MPa, preferably 10 kPa-100 MPa, but more preferably 50 kPa-100 MPa. In cases when pressing is less than 1 kPa, the effect of sufficient contact onto each particle cannot be assured, and when it is more than 100 MPa, it is difficult to maintain a flat surface of the material, resulting in undesirably increased haze. Further, heating during pressurization may be beneficial, and is preferably in the range of 40-300° C. The duration of heating depends on the temperature, being a short time at high temperature, while longer at a lower one. As a heating method, in the case of nip-roller type, one is heating rollers to a predetermined temperature while another method is to heat the material in a heating section, such as an autoclave chamber. It is preferable to laminate plural sheets of a predetermined size and to simultaneously heat them, to realize high productivity. To enhance the efficiency of the heat treatment, it is preferable to employ thermoplastic materials alone or combinations of them as a binder. It is also preferable to employ a combination of polymers exhibiting a glass transition point of less than 40° C. As such polymers, employable are a single homopolymer, or a multicomponent copolymer containing more than two components. Further, it is possible to employ a natural wax, such as Carnauba wax, an artificial wax such as a chain-extended wax, or rosins.

Further, it is allowable to employ laser heating as a heating method. The kind of laser light may be appropriately chosen based on the silver coverage, to the radiating laser beam and the adhesive agent. For example, listed as a laser light are such as a neodymium laser, a YAG laser, a ruby laser, a herium-neon laser, a krypton laser, an argon laser, an H₂ laser, a N₂ laser, and a semiconductor laser. As more preferable lasers, cited are a YAG:neodymium³⁺ laser (at a laser wavelength of 1,060 nm) and a semiconductor laser (at a laser wavelength of 500-1,000 nm). The laser beam output is preferably 5-1,000 W. The laser beam may be a continuous wavelength or a wave pulse type. If the width of a pulse wave is controlled, adjustment of heating is possible and is therefore easy to determine optimal conditions. In cases when the laser output exceeds 1,000 W, it is not desirable because ablation is generated and volatilization.evaporation tends to occur.

In cases when a near-infrared absorption dye is employed in a preferable embodiment of this invention, it is desirable to employ an infrared semiconductor laser in the range of 800-1,000 nm.

In the application of a light-transmitting electromagnetic wave shielding material, the line width of the above conductive metallic portion is preferably 20 μm or less, and a line space of it is preferably 50 μm or more. Further, the conductive metallic portion may have a part in which the line width is more than 20 μm for a ground connection. Further, from the viewpoint of not to through images into relief, it is preferable that the line width of the conductive metallic portion is not more than 18 μm, more preferably not more than 15 μm, and still more preferably not more than 14 μm, further still more preferably not more than 10 μm, and most preferably not more than 7 μm.

From the viewpoint of visible light transperency, the conductive metallic portion of this invention preferably exhibits an aperture ratio of more than 85%, more preferably 90% or more, and still more preferably 95% or more. “Aperture ratio” means the ratio of non-line areas where no thin lines form a mesh, compared to the total area of a mesh, and, for example, the aperture ratio of a square, lattice type of mesh of a line width of 10 μm and a pitch of 200 μm is 90%.

“Light transparent portion” in this invention means that portion, which exhibits transparency, other than the conductive metallic portions in the light-transmitting electromagnetic wave shielding material. The average visible light transmission in the light transparent portion is more than 90% which is shown at the average transmission value in the wavelength region of 400-700 nm, except for the light absorption and reflective contribution of the support, is preferably at least 95%, more preferably at least 97%, still more preferably at least 98%, and further is most preferably at least 99%.

The thickness of the support of the light-transmitting electromagnetic wave shielding material in this invention is preferably 5-200 μm, but more preferably 30-150 μm. If the support is in the range of 5-200 μm, the targeted visible light transmission is easily attained, and handling of it is also easy.

The appropriate thickness of the metallic silver portions applied onto the support may be measured based on the coating thickness of the coating material for the silver halide grain containing layer applied onto the support. The thickness of the metallic silver portions is preferably at most 30 μm, more preferably at most 20 μm, still more preferably 0.01-9 μm, but is most preferably 0.05-5 μm.

The thickness of the conductive metal silver portion is preferably as thin as possible whereby it is viewable at wider angles on a display for use as an electromagnetic wave shielding material of a display. Further, for use as a conductive wiring material, it is required to be still thinner due to the desirability of being dens. From this viewpoint, the thickness of the layer comprising electrical conductive metals dispersed in the conductive metallic portion is preferably thinner not more than 9 μm, more preferably from 0.1 μm to not more than 5 μm, and still more preferably from 0.1 μm to not more than 3 μm.

In this invention, a functional layer may be separately provided, if of benefit. This functional layer may be of various specifications for each application. For example, for an electromagnetic wave shielding material application for a display, provided may be an anti-reflection layer which functions by adjusting the refractive index and coating thickness; a non-glare coating or an anti-glare coating, both of which exhibit a glare decreasing function; a layer for an image color adjustment function, which absorbs visible light of a specific wavelength; an antifouling layer which functions to easily remove dirt, such as a finger-prints; a scratch-resistant hard coating layer; a layer which serves an impact-absorbing function; and a layer which functions to prevent glass scattering in case of glass breakage. These functional layers may be applied onto the support of the reverse of a silver halide grain containing layer, and may be further applied onto the same side.

These functional films may be adhered directly onto the PDP, but may also be adhered onto a transparent base material, such as a glass plate or a plastic plate, separate from the body of a plasma display panel. The functional film may be called an optical filter (or simply a filter).

To minimize reflection of outside light for maximum contrast, an anti-reflection layer having an anti-reflection function may be prepared by a single-layer or a multi-layer laminating method of a vacuum deposition method, a sputtering method, an ion plating method, or an ion beam assist method, in which an inorganic material, such as a metal oxide, a fluoride, a silicide, a boride, a carbide, a nitride, or a sulfide is laminated; or by a single-layer or a multi-layer laminating method, in which employed may be resins exhibiting different refractive indices. Further, a film provided with an antireflection treatment may be adhered onto the filter. Further, a film with a non-glare or an anti-glare treatment may be adhered onto the filter. Further, a hard-coat layer may further be adhered, if of benefit.

The layer with an image color adjustment function, which absorbs visible light of a specific wavelength, is one to correct the emitted light color, and to contain dye absorbing light near 595 nm, because the PDP exhibits a drawback to display a bluish color as a purplish blue, due to the characteristics of the blue emitting fluorescent material which emits a slightly red light. Specific examples of the dyes absorbing the specified wavelengths include well-known inorganic dyes, organic pigments, and inorganic pigments, such as an azo dye, a condensed azo dye, a phthalocyanine dye, an anthlaruinone dye, an indigo dye, a perylene dye, a dioxadine dye, a quinacridone dye, a methane dye, an isoindolinone dye, a quinophthalone dye, a pyrrole dye, a thioindigo dye, and a metal complex dye. Of these, preferred are the phthalocyanine and anthraquinone dyes, due to their excellent weather resistance.

### EXAMPLE

The present invention will be further specifically described below with reference to examples. In addition, the materials, the added amount, the ratio of those materials, the contents of treatment, and the operating scheme which are shown in the following examples may be appropriately changed, unless it deviates from the spirit of the present invention. Therefore, the extent of the present invention is not to be restrictively interpreted by the examples shown below.

### Example 1

An emulsion was prepared containing silver iodobromide grains (at an iodide content of 2.5 mol %) with an average spherical equivalent diameter of 0.044 μm, which contain 10 g of gelatin based on 100 g of silver in the aqueous medium. In this case, the Ag/gelatin weight ratio was brought to 10/1, and the employed gelatin was an alkali-treated low-molecular-weight gelatin of an average molecular weight of 40,000. Further, in this emulsion, potassium bromorhodate and potassium chloroiridate were added to the 10⁻⁷ (mole/mole silver) level, and Rh ions and Ir ions were doped onto silver bromide particles. To this emulsion, added was sodium chloropalladate, and after gold-sulfur sensitization, further employing chloroauric acid and sodium thiosulfate, spectral sensitization was conducted by addition of a spectral sensitization dye at an amount of 10⁻⁴ mol per mol of silver halide (the structures of dyes are shown in Table 1). After that, added was a hydrazine or tetrazolium compound as a contrast increasing agent (the numbers of the specific examples are shown in Table 1), and an amine compound or a pyridine compound as an accelerator (again, the numbers of specific examples are shown in Table 1). Further, in order to promote silver grain contact during pressing, the emulsion was applied onto polyethylene terephthalate (PET) at a silver coverage of 10 g/m² (being a gelatin coverage of 1 g/m²) together with rosin and Carnauba wax to each become 0.1 g/m², and a vinyl sulfone gelatin hardening agent of 0.1 g/m² (being 0.1 mol per g of gelatin). Before coating, the PET film was made hydrophilic by a corona discharge treatment (being 100 mw/m²) on both sides. Onto one side of the PET, applied were a gelatin layer (at a gelatin coverage of 1 g/m²) and a protective layer (at a gelatin coverage of 1 g/m², as well as one incorporating a silica matting agent at an average particle diameter of 3 μm). The gelatin layer contained an imonium infrared absorption dye (at a dye coverage of 0.1 g/m², specific examples of which are shown in Table 1) and an ultraviolet absorption dye (at a dye coverage of 0.1 g/m², specific examples of which are also shown in Table 1), both of these were added in the form of solid dispersed particles at an average particle diameter of less than 100 nm. This coated sample was then dried. Thus, prepared were silver halide photographic materials of Sample Nos. 101-118, and Sample No. 100 as a comparative sample which was Sample A in Example 1 of JP-A 2004-221564, as shown in Table 1.

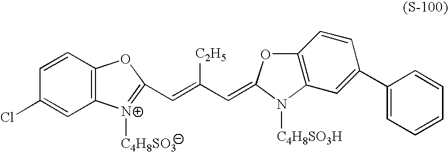

Sample Nos. 100-118, prepared as above, were exposed to obtain a drawing pattern of developed silver images of a line/space of 5 μm/195 μm, employing an LD excitation solid laser (at a wavelength of 532 nm) and a near-infrared semiconductor laser (at a wavelength of 810 nm) employing an image setter. Exposed Samples were developed with the following developing solution at 25° C. for 45 seconds, and further, fixing was conducted employing the following fixing solution, and then rinsed with pure water.

Developing Solution Composition

| | | |
|---|---|---|
| Hydroquinone | 30 | g |
| 1-phenyl-3,3-dimethylpyrazolidone | 1.5 | g |
| Potassium bromide | 3.0 | g |
| Sodium sulfite | 50 | g |
| Potassium hydroxide | 30 | g |
| Boric acid | 10 | g |
| N-n-butyldiethanolamine | 15 | g |
| Water | to make 1 | L |
| The pH was adjusted to 10.20. | | |

Fixing Solution Composition

| | | |
|---|---|---|
| 72.5% ammonium thiosulfate aqueous solution | 240 | ml |
| Sodium sulfite | 17 | g |
| Sodium acetate trihydrate | 6.5 | g |
| Boric acid | 6.0 | g |
| Sodium citrate dehydrate | 2.0 | g |
| 90% acetic acid aqueous solution | 13.6 | ml |
| 50% sulfuric acid aqueous solution | 4.7 | g |
| Aluminium sulfate (being an aqueous solution | 26.5 | g |
| of converted content to AL₂O₃ of 8.1% W/V) | | |
| Water | to make 1 | L |
| The pH was adjusted to 5.0. | | |

After development of the Samples, pressing of 0.1 kPa-100 MPa and heat treatment of 35-320° C. changing a period of time were conducted in an autoclave.

The line width and the surface resistance value of the conductive metallic portions of Samples which exhibited the conductive metallic portions and the light transparent portions obtained as above were measured. With the electromagnetic wave shielding measuring method (being the KEC method) by Kansai Electronic Industry Development Center, the electromagnetic wave attenuation effect was measured, and then the electromagnetic wave attenuation effects (dB) at 100 MHz were compared. The surface resistance value was measured employing Digital Multimeter 7541 manufactured by Yokogawa Electric Corp. In the present invention, since the mesh of metal wires was protected by the protective layer, the resistance value was determined by measurement through this overcoat. Measurement of the resistance value was conducted in a room at 23° C. and 50% relative humidity. The compositions of the prepared samples are listed in Table 1, and the evaluated results of those are shown in Table 2.

TABLE 1

| | Silver halide grain | | | | Dye preparation | | | | | | |
|---|---|---|---|---|---|---|---|---|---|---|---|
| | preparation | | | | | Ultraviolet | Treatment condition | | | | |
| Sample | | | | Redox | | absorption | Pressuring | | Heating | Heating | |
| No. | *1 | *2 | Accelerator | compound | *3 | dye | (Pa) | | temperature | duration | |
| 100 | None | None | None | None | None | None | No | | No heating | 0 | |
| | | | | | | | pressure | | | | |
| 101 | (S-100) | (H-1) | (A-10) | (R-1) | (IR-1) | (UV-1) | 0.1 | kPa | No heating | 0 | |
| 102 | (S-100) | (H-1) | (A-10) | (R-1) | (IR-1) | (UV-1) | 5 | kPa | No heating | 0 | |
| 103 | (S-100) | (H-1) | (A-10) | (R-1) | (IR-1) | (UV-1) | 500 | kPa | No heating | 0 | |
| 104 | (S-100) | (H-1) | (A-10) | (R-1) | None | None | 500 | kPa | No heating | 0 | |
| 105 | (S-11) | (H-1) | (A-10) | (R-1) | (IR-1) | (UV-1) | 0.1 | kPa | No heating | 0 | |
| 106 | (S-11) | (H-1) | (A-11) | (R-1) | (IR-1) | (UV-1) | 5 | kPa | No heating | 0 | |
| 107 | (S-11) | (H-2) | (A-12) | (R-1) | (IR-2) | (UV-2) | 500 | kPa | No heating | 0 | |
| 108 | (S-11) | (H-1) | (A-13) | (R-1) | (IR-3) | (UV-3) | 5 | MPa | No heating | 0 | |
| 109 | (S-11) | (H-2) | (A-14) | (R-1) | (IR-4) | (UV-4) | 50 | MPa | No heating | 0 | |
| 110 | (S-11) | (H-1) | (A-15) | (R-1) | (IR-5) | (UV-5) | 100 | MPa | No heating | 0 | |
| 111 | (S-11) | (T-1) | (A-10) | (R-2) | (IR-1) | (UV-1) | 50 | kPa | 35° C. | 3 | hr. |
| 112 | (S-11) | (T-1) | (A-11) | (R-2) | (IR-2) | (UV-1) | 50 | kPa | 42° C. | 46 | min. |
| 113 | (S-11) | (T-1) | (A-12) | (R-2) | (IR-3) | (UV-2) | 50 | kPa | 80° C. | 12 | min. |
| 114 | (S-11) | (T-1) | (A-13) | (R-2) | (IR-4) | (UV-3) | 50 | kPa | 140° C. | 2 | min. |
| 115 | (S-11) | (T-1) | (A-14) | (R-2) | (IR-1) | (UV-4) | 50 | kPa | 180° C. | 4 | sec. |
| 116 | (S-11) | (T-1) | (A-15) | (R-2) | (IR-2) | (UV-1) | 50 | kPa | 230° C. | 3 | sec. |
| 117 | (S-11) | (T-1) | (A-11) | (R-2) | (IR-3) | (UV-2) | 50 | kPa | 280° C. | 2 | sec. |
| 118 | (S-11) | (T-1) | (A-12) | (R-2) | (IR-4) | (UV-3) | 50 | kPa | 320° C. | 1 | sec. |

*1: Sensitizing dye,
*2: Contrast increasing agent,
*3: Near-infrared absorption dye

TABLE 2

| | Result | | | |
|---|---|---|---|---|
| | Surface | Visible light | Infrared | |
| Sample | resistance | transmission | absorption | |
| No. | (Ω/sq.) | (%) | (800-1,000 nm) | Remarks |
| 100 | 0.06 | 87 | 0 | Comp. |
| 101 | 120 | 87 | 80 | Comp. (low |
| | | | | pressing) |
| 102 | 15 | 87 | 80 | Inv. |
| 103 | 0.1 | 87 | 80 | Inv. |
| 104 | 0.2 | 68 | 0 | Comp. |
| 105 | 100 | 87 | 80 | Comp. (low |
| | | | | pressing) |
| 106 | 10 | 87 | 80 | Inv. |
| 107 | 0.1 | 88 | 80 | Inv. |
| 108 | 0.06 | 89 | 80 | Inv. |
| 109 | 0.05 | 90 | 80 | Inv. |
| 110 | 0.04 | 91 | 80 | Inv. |
| 111 | 0.05 | 88 | 80 | Inv. |
| 112 | 0.05 | 88 | 80 | Inv. |
| 113 | 0.05 | 88 | 80 | Inv. |
| 114 | 0.05 | 88 | 80 | Inv. |
| 115 | 0.05 | 88 | 80 | Inv. |
| 116 | 0.05 | 88 | 80 | Inv. |
| 117 | 0.05 | 88 | 80 | Inv. |
| 118 | 0.05 | 88 | 80 | Inv. |

Comp.: Comparative example, Inv.: This invention

When Sample Nos. 101-118 of the present invention were compared to the light-transmitting electrical conductive material (being Sample No. 100) as a comparative example, surface resistance was equivalent to each and it turned out that both exhibited the same level of light transparency and electrical conductivity (representing the electromagnetic wave shielding capability). However, the samples of this invention are not required to undergo a troublesome plating treatment as required of the comparative samples. The electromagnetic wave shielding capability is enhanced to an amazing degree by conducting a pressing treatment or a heating treatment. Further in the present invention, when near-infrared absorption capability is measured, it turns out that Samples of this invention exhibit sufficient absorption capability, tending to not produce erroneous operating signals.

### Example 2

In order to achieve higher electrical conductivity, the high Ag/gelatin weight ratio was changed, after which the following experiments were conducted. Samples of this invention of Sample Nos. 301-309 were prepared by changing the Ag/gelatin weight ratio to 0.2-100 by alternating the gelatin amount of Sample 107 of Example 1, employing a line width of 10 μm to form the metallic mesh. After conducting pressing at 500 kPa after development, the surface resistance was determined employing the same method as that of Example 1 of this invention. Further, near-infrared absorption capability was measured in a manner similar to Example 1. Shimazu FTIR-8300 was used as an infrared absorption spectrometer. The compositions of the prepared samples and the evaluated results of those are all shown together in Table 3.

TABLE 3

| | | Result of performance | | | |
|---|---|---|---|---|---|
| | Ag/gelatin | Surface | | Near-infrared | |
| Sample | weight | resistance | Visible light | absorption | |
| No. | ratio | (Ω/sq.) | transmission (%) | (at 800-1,000 nm) | Remarks |
| 301 | 0.2 | 100.00 | 88 | 80 | Inv. |
| 302 | 2 | 2.00 | 88 | 80 | Inv. |
| 303 | 10 | 0.10 | 88 | 80 | Inv. |
| 304 | 30 | 0.08 | 88 | 80 | Inv. |
| 305 | 40 | 0.06 | 88 | 80 | Inv. |
| 306 | 50 | 0.05 | 88 | 80 | Inv. |
| 307 | 65 | 0.04 | 88 | 80 | Inv. |
| 308 | 83 | 0.04 | 88 | 80 | Inv. |
| 309 | 100 | 0.03 | 88 | 80 | Inv. |

Inv.: This invention

In the present invention, it is found that higher electrical conductivity can be attained by an enlarged Ag/binder (gelatin) weight ratio. Further, it is preferable to also enlarge the Ag/binder weight ratio with respect to light transmission (translucency). The Ag/gelatin ratio is preferably 10 or more, because in the case where the conductive material is employed for PDP, the required conductivity is at most 10 Ω/sq.

### Example 3

Experimentmentation for Example 3 was conducted in the same manner as for Example 1, except that the heat treatment was changed to a heat-ray pulse infrared laser to accelerate contact of silver halide grains. In this experiment, the thin drawn lines were heated employing an infrared pulse semiconductor laser (having a pulse wave width of 10 msec., manufactured by Frankfurt GmbH.) at an output of 15 W and 50 W at wavelengths of 800-870 nm, resulting in increased contact among the grains. Samples Nos. 107 and 111 of Example 1 were employed for this experiment, and laser heating was conducted without pressing. The compositions of the prepared samples and the results are shown in Table 4.

TABLE 4

| | | Infrared | | | | | |
|---|---|---|---|---|---|---|---|
| | | semiconductor | | | | | |
| | | laser | | Results | | | |
| | | Heating | Heating | Surface | Visible light | Near-infrared | |
| Sample | Heated | output | duration | resistance | transmission | absorption | |
| No. | sample | (W) | (sec) | (Ω/sq.) | (%) | (at 800-1,000 nm) | Remarks |
| 401 | 107 of | 15 W | 3 | 0.05 | 88 | 80 | Inv. |
| | Example 1 | | | | | | |
| 402 | 107 of | 15 W | 6 | 0.05 | 88 | 80 | Inv. |
| | Example 1 | | | | | | |
| 403 | 107 of | 15 W | 9 | 0.05 | 88 | 80 | Inv. |
| | Example 1 | | | | | | |
| 404 | 107 of | 15 W | 12 | 0.05 | 88 | 80 | Inv. |
| | Example 1 | | | | | | |
| 405 | 111 of | 50 W | 1 | 0.02 | 88 | 80 | Inv. |
| | Example 1 | | | | | | |
| 406 | 111 of | 50 W | 2 | 0.02 | 88 | 80 | Inv. |
| | Example 1 | | | | | | |
| 407 | 111 of | 50 W | 3 | 0.02 | 88 | 80 | Inv. |
| | Example 1 | | | | | | |
| 408 | 111 of | 50 W | 4 | 0.02 | 88 | 80 | Inv. |
| | Example 1 | | | | | | |

Inv.: This invention

It is found that laser heating also achieves a side-effect of electromagnetic wave shielding.

What is claimed is:

1. A method of manufacturing an electromagnetic wave shielding material comprising the steps of:
(a) forming an image of metallic silver grains by conducting exposure and photographic processing to a silver halide photographic material comprising a support, thereon at least one near-infrared absorption layer, and a silver halide emulsion layer containing silver halide grains; and
(b) converting the image of metallic silver grains to an electrical conductive image by treatment of pressing or heating.

2. The method of manufacturing the electromagnetic wave shielding material of claim 1, wherein the silver halide grains are sensitized to near-infrared rays, and the silver halide photographic material is subjected to near-infrared exposure.

3. The method of manufacturing the electromagnetic wave shielding material of claim 1, wherein the near-infrared absorption layer of the silver halide photographic material is provided between the silver halide emulsion layer and the support, or on a surface of the support opposite to the silver halide emulsion layer.

4. The method of manufacturing the electromagnetic wave shielding material of claim 1, wherein a near-infrared absorption intensity of the near-infrared absorption layer does not change by photographic processing.

5. The method of manufacturing the electromagnetic wave shielding material of claim 1, wherein an unexposed portion which is not exposed by the near-infrared exposure contains substantially no silver nor silver halide after photographic processing.

6. The method of manufacturing the electromagnetic wave shielding material of claim 1, wherein the pressing is conducted at a pressure of 1 kPa to 100 MPa.

7. The method of manufacturing the electromagnetic wave shielding material of claim 1, wherein heating is conducted at a temperature of 40 to 300° C.

8. The method of manufacturing the electromagnetic wave shielding material of claim 7, wherein heating is via laser heating.

9. An electromagnetic wave shielding material, manufactured by the method of manufacturing the electromagnetic wave shielding material described in claim 1, exhibiting:
(i) at least one characteristic of surface resistance of not more than 10 Ω/sq. or an average visible light transmission of not less than 90%;
(ii) electrical conductive portions; and
(iii) a near-infrared absorption layer.

10. An electromagnetic wave shielding material for a plasma display panel comprising the electromagnetic wave shielding material of claim 9.
